(19) United States
(12) Patent Application Publication
(10) Pub. No.: US 2006/0051081 A1
(43) Pub. Date: Mar. 9, 2006

(54) Shake correction control apparatus and imaging apparatus using same shake correction control apparatus

(75) Inventor: Akira Ogino, Sakai-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 11/220,019

(22) Filed: Sep. 6, 2005

(30) Foreign Application Priority Data
Sep. 6, 2004 (JP) 2004-258083

(51) Int. Cl. G03B 17/00

(52) U.S. Cl. 396/55

(57) ABSTRACT

The imaging apparatus of the invention comprises: image pickup means for acquiring as an image a part of region of an optical image formed by a taking lens; camera shake correcting means for changing a relative position between the part of region and the optical image depending on a vibration of the imaging apparatus, and thereby suppressing a shake of the object image in the image; state detecting means for detecting a state of an environment where the imaging apparatus is located; and changing means for changing a control value of the camera shake correcting means which influences a driving sound level of the camera shake correcting means, depending on the state of environment. According to this configuration, the control value of the camera shake correcting means is changed depending on the state of environment. This permits appropriate balance between the silence performance and the camera shake correction performance.

This application is based on Japanese Patent Application No. 2004-258083 filed in Japan on 6 Sep. 2004, the entire content of which is hereby incorporated by reference.

### FIELD OF THE INVENTION

The present invention relates to an imaging apparatus comprising camera shake correcting means for suppressing a shake (blurring) of an object image in an image.

### DESCRIPTION OF RELATED ART

In general, when an imaging apparatus held solely by human hands is used to take an image of a photographic object, a minute vibration occurs in the imaging apparatus so that the optical axis of the taking lens moves relative to the photographic object. Thus, a shake (blurring) called a “camera shake (in-the-hand shake)” occurs in the object image in the acquired image.

In the prior art, an imaging apparatus such as a digital camera has been known that employs a camera shake correction mechanism for correcting such a camera shake. In such a camera shake correction mechanism, a plurality of angular velocity sensors or the like detect the vibration of the imaging apparatus. Then, in response to the detected vibration, a correcting lens in the taking lens, an image pickup device, or the like are moved such that the position of the optical image (image circle) formed by the taking lens is changed relative to the area acquired by the image pickup device, so that the camera shake is corrected (see, for example, JP-A No. 2003-110929).

In addition, JP-A No. 2002-344787 is prior art document information relevant to this application.

Meanwhile, in the above-mentioned camera shake correction mechanism, the correcting lens or the image pickup device is moved, and hence driving sound is generated in the camera shake correction operation. Nevertheless, this driving sound causes various problems.

For example, in a place like a museum and an exhibition hall where silence is requested, the driving sound of the camera shake correction mechanism can cause annoyance to the neighbors. Alternatively, in the case of an imaging apparatus in which the environmental sound (audio) obtained through the microphone can be recorded simultaneously with the video image obtained by the image pickup device, the driving sound of the camera shake correction mechanism can be mixed as a noise into the recorded audio signal.

Thus, the level of the driving sound of the camera shake correction mechanism is desired to be reduced as much as possible. A possible technique for reducing the driving sound level is to reduce the drive current value for driving the camera shake correction mechanism. Nevertheless, when the drive current value is simply reduced in every case, the camera shake correction performance is degraded at the same time of the reduction in the driving sound level. That is, when the driving sound level is reduced, in other words, when priority is imparted to the silence performance, the camera shake correction performance is degraded. On the contrary, when priority is imparted to the camera shake correction performance, the silence performance is degraded. As such, the “silence performance” and the “camera shake correction performance” conflict and compete with each other.

### SUMMARY OF THE INVENTION

The invention has been devised in view of these problems. An object of the invention is to provide an imaging apparatus in which appropriate balance is achieved between the silence performance and the camera shake correction performance.

This object is achieved by providing the following configuration.

An imaging apparatus of the invention comprises: image pickup means for acquiring as an image a part of region of an optical image formed by a taking lens; camera shake correcting means for changing a relative position between the part of region and the optical image depending on a vibration of the imaging apparatus, and thereby suppressing a shake of the object image in the image; state detecting means for detecting a state of an environment where the imaging apparatus is located; and changing means for changing a control value of the camera shake correcting means which influences a driving sound level of the camera shake correcting means, depending on the state of environment.

According to this configuration, the control value of the camera shake correcting means is changed depending on the state of environment. This permits appropriate balance between the silence performance and the camera shake correction performance.

In the above-mentioned imaging apparatus, the state detecting means includes sound detecting means for detecting environmental sound, wherein the changing means changes the control value depending on the sound level of the environmental sound.

According to this configuration, although the severity of problem caused by the driving sound varies depending on the sound level of the environmental sound, the control value is changed depending on the sound level of the environmental sound. This permits more appropriate balance between the silence performance and the camera shake correction performance.

The above-mentioned imaging apparatus further comprises: generating means for generating a video image on the basis of the image acquired by the image pickup means; and recording means for recording as a video file the video image together with the environmental sound.

According to this configuration, the influence of a noise caused by the driving sound of the camera shake correcting means is suppressed that affects the environmental sound contained in the video file recorded.

In the above-mentioned imaging apparatus, the changing means sets the control value to be a first value causing the driving sound level to become comparatively high when the sound level of the environmental sound is higher than a threshold value, and sets the control value to be a second value causing the driving sound level to become comparatively low when the sound level of the environmental sound is lower than the threshold value.

According to this configuration, when the sound level of the environmental sound is low, the silence performance is improved so that a problem caused by the driving sound of the camera shake correcting means can be avoided effectively. In contrast, when the sound level of the environmental sound is high, a large problem does not arise even if the driving sound level is somewhat high. Thus, the camera shake correction performance can be improved.

The above-mentioned imaging apparatus further comprises first receiving means for receiving from a user an activation setting that specifies whether the changing means is to be activated or not, wherein the changing means is activated or inactivated according to the activation setting.

According to this configuration, when a user desires, it can be set up such that the silence performance may not be changed.

The above-mentioned imaging apparatus further comprises second receiving means for receiving from a user a user setting value to be set as the control value when the changing means is inactivated, wherein when the changing means is inactivated, the control value is set to be the user setting value.

According to this configuration, the degree of silence performance can be set at a value desired by a user.

The above-mentioned imaging apparatus further comprises threshold value setting means in which when the control value is at the first value, the threshold value is set to be comparatively small, while when the control value is at the second value, the threshold value is set to be comparatively large.

According to this configuration, when the control value has once been changed, the control value is not immediately changed after that. This avoids that the driving sound level is changed frequently.

In the above-mentioned imaging apparatus, the changing means is inactivated until a predetermined time elapses after the changing means has changed the control value.

According to this configuration, when the control value has once been changed, the control value is not immediately changed after that. This avoids that the driving sound level is changed frequently.

### BRIEF DESCRIPTION OF THE DRAWINGS

These and other objects and features of the present invention will become clear from the following description taken in conjunction with the preferred embodiments thereof with reference to the accompanying drawings, in which:

FIG. 1 is a sectional view showing the main configuration of a digital camera.

FIG. 2 is an exploded perspective view of a CCD moving section.

FIG. 3 is a block diagram showing the main functional configuration of a digital camera.

FIG. 4 is a diagram showing the outline of operation in a static image photographing mode.

FIG. 5 is a diagram showing the outline of operation in a video shooting mode.

FIG. 6 is a diagram showing the flow of operation of camera shake correction processing.

FIG. 7 is a diagram showing the flow of electric current value setting processing according to a first embodiment.

FIG. 8 is a diagram showing a setting menu used for receiving a performance change setting from a user.

FIG. 9 is a diagram showing a setting menu used for receiving a performance change setting from a user.

FIG. 10 is a diagram showing the flow of electric current value setting processing according to a second embodiment.

FIG. 11 is a diagram showing the flow of electric current value setting processing according to a third embodiment.

FIG. 12 is a diagram showing the flow of electric current value setting processing according to a fourth embodiment.

### DETAILED DESCRIPTION OF THE PREFERRED EMBODIMENTS

Embodiments of the invention are described below with reference to the drawings.

### 1. First Embodiment

<1-1. Configuration of Digital Camera>

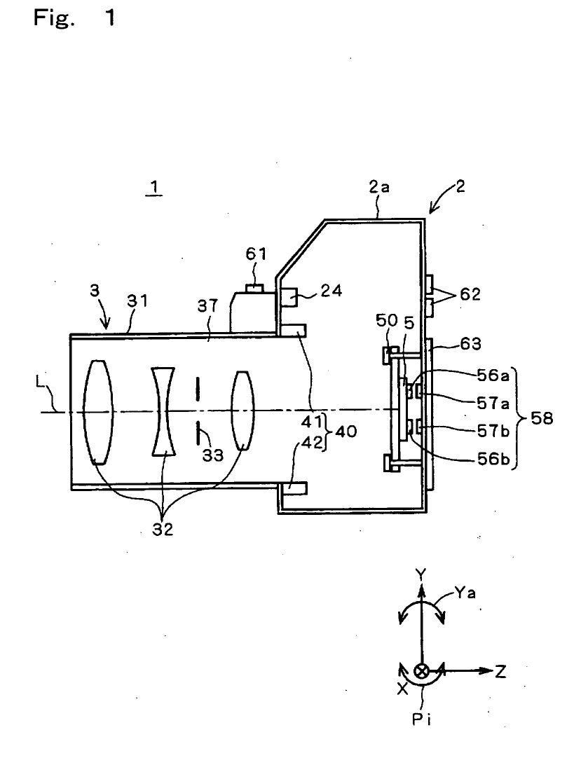

FIG. 1 is a sectional view showing the main configuration of a digital camera 1 serving as an imaging apparatus according to an embodiment of the invention. The digital camera 1 has a camera shake correction function for correcting (suppressing) a blurring of the object image in the image caused by a camera shake. As shown in the figure, in a general view, the digital camera 1 comprises: a camera body section 2; and a taking lens 3 fixed to a housing 2a of the camera body section 2.

In the following description, the three-dimensional XYZ orthogonal coordinate system shown in the figure is appropriately used for specifying the direction and orientation. Here, the Z axis aligns with the optical axis L of the taking lens 3, while the positive direction of the Z axis indicates the direction of propagation of incident light (right-hand direction in the figure). The Y axis is in the vertical direction, while the positive direction of the Y axis indicates the vertically upward direction (upward direction within the figure). The X axis is in the direction perpendicular to the figure (the page), while the positive direction of the X axis indicates the downward direction perpendicular to the figure (the page). These X, Y, and Z axes are fixed relative to the housing 2a of the camera body section 2.

In a general view, the taking lens 3 comprises: a lens barrel 31; and a plurality of lens groups 32 and a diaphragm 33 provided inside the lens barrel 31. The lens groups 32 include: a zoom-purpose lens for changing the focal length (photographing magnification); and a focusing-purpose lens for changing the focus position (focusing state of the object image). The optical image formed through the taking lens 3 has an approximately circular shape centered at the position of the optical axis on the XY plane (“image formation plane”, hereafter) where image formation is performed, and hence is called the “image circle”.

A CCD 5 retained in the housing 2a of the camera body section 2 is arranged in a downward part of the optical axis L of the taking lens 3 (positive direction of the Z axis). The CCD 5 is an image pickup device composed of a group of fine pixels each provided with a color filter, and performs photoelectric conversion of an optical image formed by the taking lens 3 into an image signal having RGB color components or the like. The image formation plane described above is adjusted such as to align with the light acceptance surface of the CCD 5. Thus, a part of area in the image circle is acquired as an image.

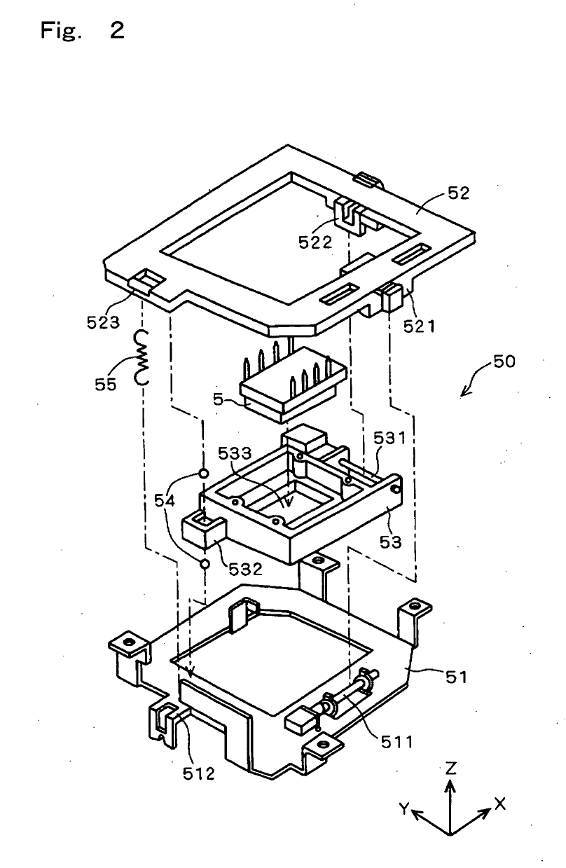

The CCD 5 is arranged and fixed in a CCD moving section 50. The CCD moving section 50 allows the CCD 5 to move in the XY plane perpendicular to the Z axis. FIG. 2 is an exploded perspective view of the CCD moving section 50 including the CCD 5.

As shown in FIG. 2, in a general view, the CCD moving section 50 comprises three members: a base plate 51 fixed to the housing 2a; a first slider 52 for traveling in the X axis direction relative to the base plate 51; and a second slider 53 for traveling in the Y axis direction relative to the first slider 52.

In the center section of the base plate 51, an opening is provided that allows incident light from the taking lens 3 to pass through. Further, the base plate 51 comprises: a first actuator 511 extending in the X axis direction; and a first spring claw 512 for hanging the spring 55. An opening 533 for fixing the CCD 5 is formed in the center section of the second slider 53. Further, the second slider 53 comprises: a second actuator 531 extending in the Y axis direction; and a rigid ball receptacle 532 in which a rigid ball 54 is loosely fitted in on each side in the positive or negative direction of the Z axis. An opening is provided in the center section of the first slider 52. Further, the first slider 52 comprises: a first frictional coupling section 521 opposing the first actuator 511; and a second frictional coupling section 522 opposing the second actuator 531. Further, in the first slider 52, a second spring claw 523 for hanging the spring 55 is provided opposite to the first spring claw 512.

Each of the first actuator 511 and the second actuator 531 comprises a driving rod capable of being freely driven in the extending direction. On the basis of a driving signal provided to the actuator 511 or 531, each driving rod moves depending on the amount and the direction indicated by the driving signal.

When the CCD moving section 50 is assembled, the CCD 5 is fitted in and fixed to the opening 533 of the second slider 53. Further, frictional coupling is formed between the driving rod of the first actuator 511 and the first frictional coupling section 521, while frictional coupling is formed between the driving rod of the second actuator 531 and the second frictional coupling section 522. The base plate 51 and the first slider 52 are biased in the mutually approaching direction by the spring 55. At that time, the second slider 53 is located between the base plate 51 and the first slider 52 via the rigid balls 54. As a result, in the direction from the negative side to the positive side of the Z axis, the base plate 51, the second slider 53, and the first slider 52 are stacked in this order, so that these members 51, 53, and 52 are arranged.

In a state that the CCD moving section 50 is assembled, when the driving rod of the first actuator 511 moves, the motion of the first frictional coupling section 521 in frictional coupling to the rod causes the first slider 52 to travel in the X axis direction relative to the base plate 51. At that time, the motion of the first slider 52 causes the second slider 53 to travel in the X axis direction relative to the base plate 51. Further, when the driving rod of the second actuator 531 moves, the motion of the second frictional coupling section 522 in frictional coupling to the rod causes the second slider 53 to travel in the Y axis direction relative to the first slider 52. At that time, the first slider 52 does not travel relative to the base plate 51. Thus, the second slider 53 solely travels in the Y axis direction relative to the base plate 51.

As described above, the base plate 51 is fixed to the housing 2a, while the CCD 5 is fixed to the second slider 53. Thus, the CCD 5 travels on the XY plane (image formation plane) relative to the housing 2a. Further, the taking lens 3 is fixed to the housing 2a. Thus, the position of the image circle formed by the taking lens 3 is fixed relative to the housing 2a. As a result, the configuration of the above-mentioned CCD moving sections 50 allows the optical image (image circle) formed by the taking lens 3 to travel relative to the position of the light acceptance surface of the CCD 5. That is, the position of a part of area acquired as an image can be changed relative to the entire image circle.

Returning to FIG. 1, a CCD position sensor 58 for detecting the position of the traveling CCD 5 is arranged on the positive side of the Z axis relative to the CCD 5. The CCD position sensor 58 comprises: two light projecting sections 56a and 56b each composed of a light emitting diode or the like; and two light receiving sections 57a and 57b each composed of a photodiode or the like. The light projecting sections 56a and 56b are fixed to the rear face of the CCD 5 (positive direction of the Z axis), while the light receiving sections 57a and 57b are fixed to the housing 2a of the camera body section 2 in a manner opposing the light projecting sections 56a and 56b, respectively. The light projected from the light projecting sections 56a and 56b can be received by the light receiving sections 57a and 57b, so that the position of the CCD 5 is obtained as an XY coordinate position on the basis of a change in the position of the light received by the light receiving sections 57a and 57b. Specifically, the first light projecting section 56a and the first light receiving section 57a detect the position of the CCD 5 in the X axis direction, while the second light projecting section 56b and the second light receiving section 57b detect the position of the CCD 5 in the Y axis direction. This CCD position sensor 58 may be constructed from a magnetic field generating member (typically, an electromagnet or a permanent magnet) and a magnetic field sensor.

A vibration sensor 40 for detecting a vibration caused by a shake of the digital camera 1 is provided inside the housing 2a of the camera body section 2. The vibration sensor 40 comprises two angular velocity sensors (a first angular velocity sensor 41 and a second angular velocity sensor 42). The first angular velocity sensor 41 detects the angular velocity of a rotational vibration (pitching) Pi around the X axis, while the second angular velocity sensor 42 detects the angular velocity of the rotational vibration (yawing) Ya around the Y axis. On the basis of the two angular velocities detected by the vibration sensor 40, the CCD moving section 50 moves the CCD 5 in the two directions of the X axis and the Y axis, so that the shake of the object image in the image is corrected, that is, camera shake correction is achieved. As such, in the digital camera 1, the CCD moving section 50 serves as a major component of the drive mechanism (camera shake correction mechanism) for the camera shake correction function.

In the upper face of the camera body section 2, a shutter button 61 is provided. The shutter button 61 is a button used for receiving an instruction for image pickup (exposure start) or the like from the user. In the front face of the camera body section 2, a microphone 24 is provided that detects the environmental sound around the place where the digital camera 1 is located.

On the other hand, the rear face of the camera body section 2 is provided with an operating member 62 used for receiving various kinds of user's operation; and a display section 63 for displaying a setting screen (setting menu) or an image. The operating member 62 includes: a power switch for switching the ON and OFF of a power supply; a cross key used for receiving an instruction concerning the direction; a determination button used for receiving an instruction of determination; and a mode changing switch used for receiving an instruction of changing the mode of operation of the digital camera 1.

The modes of operation of the digital camera 1 of the present embodiment include: a “static image photographing mode” in which a photographic object is photographed and recorded as a static image; a “video shooting mode” in which a photographic object is shot and recorded as a video image; and a “reproduction mode” in which the recorded image is reproduced and displayed.

The display section 63 comprises a liquid crystal display or the like capable of performing color display. In the photographing standby state for the “static image photographing mode” or the “video shooting mode”, the display section 63 performs live view display in which an image showing the present state of the photographic object is displayed live (in real-time). The user can check the present state of the photographic object through the live view display in the display section 63, so that the display section 63 serves as a finder. Further, in the “reproduction mode”, the static image or the video image having been recorded is reproduced and displayed in the display section 63.

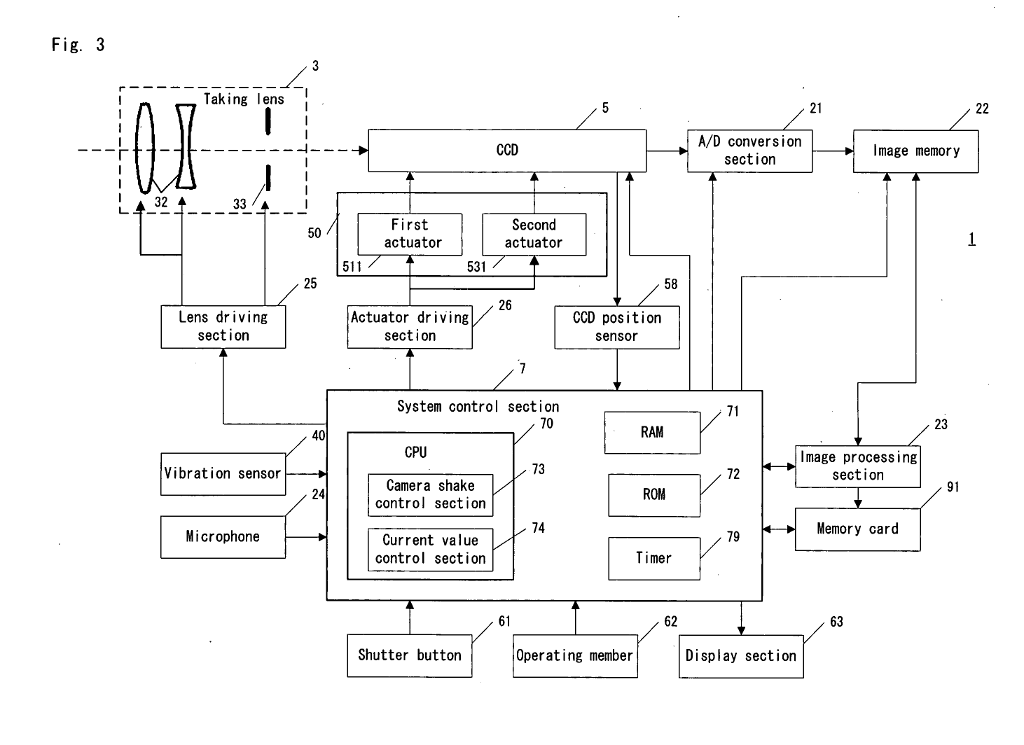

A memory card 91 (see FIG. 3) for recording various data can be inserted and attached to the inside of the camera body section 2. In the memory card 91, the static image and the video image generated from the image acquired by the CCD 5 are recorded as predetermined format files.

Various kinds of functions of the digital camera 1 including the camera shake correction function are performed under the control of the system control section provided within the housing 2a of the camera body section 2. FIG. 3 is a diagram showing as functional blocks the main functional configuration of the digital camera 1 including the system control section 7.

As shown in FIG. 3, the system control section 7 for controlling the entire apparatus is provided inside the digital camera 1. The above-mentioned various parts of the digital camera 1 (including the CCD 5, the CCD moving section 50, the CCD position sensor 58, the vibration sensor 40, the microphone 24, the shutter button 61, the operating member 62, and the display section 63) are electrically connected to the system control section 7, and thereby operate under the control of the system control section 7. Further, the position of the CCD 5 detected by the CCD position sensor 58, the angular velocity detected by the vibration sensor 40, the environmental sound detected by the microphone 24, the operation contents of the shutter button 61 and the operating member 62, and the like are inputted as signals to the system control section 7.

The lens driving section 25 drives a plurality of the lens groups 32 and the diaphragms 33 which are provided in the taking lens 3, and adjusts the focal length and the focus position of the taking lens 3 as well as the aperture diameter of the diaphragm 33. The lens driving section 25 is also electrically connected to the system control section 7, and thereby operates under the control of the system control section 7.

The actuator driving section 26 drives the first actuator 511 and the second actuator 531 of the CCD moving section 50. Specifically, on the basis of a signal from the system control section 7, the actuator driving section 26 transmits driving signals to the actuators 511 and 531 so as to move the CCD 5 in a necessary direction by a necessary amount.

Further, on the basis of a signal from the system control section 7, the actuator driving section 26 adjusts the drive current value for driving the actuators 511 and 531. When the drive current value is changed, the driving speed of the actuators 511 and 531 varies depending on the value. Thus, the drive current value serves as a camera shake correction function control value that specifies the camera shake correction performance. That is, when the drive current value is set to be comparatively high, the response of the CCD moving section 50 becomes faster so that the camera shake correction performance is improved. On the contrary, when the drive current value is set to be comparatively low, the response of the CCD moving section 50 becomes slower so that the camera shake correction performance is degraded. On the other hand, the drive current value serves also as a control value specifying the silence performance, and influences the sound level (simply referred to as the “driving sound level”, hereafter) of the driving sound generated by the CCD moving section 50. That is, when the drive current value is set to be comparatively high, the driving sound level generated in the CCD moving section 50 becomes comparatively high so that the silence performance is degraded. On the contrary, when the drive current value is set to be comparatively low, the driving sound level generated in the CCD moving section 50 becomes comparatively low so that the silence performance is improved.

In FIG. 3, the A/D conversion section 21, the image memory 22, and the image processing section 23 serve as a processing section for processing the image acquired by the CCD 5. That is, the image in the form of an analog signal acquired by the CCD 5 is converted into a digital signal by the A/D conversion section 21, and then stored into the image memory 22. The image stored in the image memory 22 undergoes predetermined image processing in the image processing section 23, then converted into a predetermined format file, and then recorded into the memory card 91. In the “static image photographing mode”, the image obtained by the CCD 5 is converted into an image file of Exif form or the like, and then recorded. On the other hand, in the “video shooting mode”, on the basis of a plurality of images obtained by the CCD 5, a video image is generated. Then, the environmental sound obtained through the microphone 24 is added as audio for the video to the video image, so that a video file is obtained and recorded. Various kinds of such image processing performed on the image by the image processing section 23 and the like are performed also under the control of the system control section 7.

The system control section 7 is provided with a microcomputer. That is, the system control section 7 comprises: a CPU 70 for performing various data processing; a RAM 71 used as a working area for arithmetic operation; a ROM 72 for storing a control program and the like; and a timer 79 serving as a time counting circuit, and thereby controls comprehensively the operation of each part of the digital camera 1 described above.

Various kinds of functions of the system control section 7 are implemented by the CPU 70 performing arithmetic processing according to the control program stored in the ROM 72. This control program is stored in the ROM 72 in advance. However, for example, a new control program may be read from the memory card 91, and then stored into the ROM 72.

The functions of the system control section 7 realized by the arithmetic operation of the CPU 70 according to the control program include: an operation control function of controlling the operation of each part of the digital camera 1 described above; an exposure control function of adjusting the diaphragm value (corresponding to the aperture diameter of the diaphragm 33) and the exposure time (corresponding to the shutter speed) so as to realize an appropriate image brightness; an auto focusing function of adjusting the focus position such that the object image should be focused; and other various functions. FIG. 3 showing the camera shake control section 73 and the electric current value control section 74 illustrates the schematic configuration for performing a part of such functions of the system control section 7.

The camera shake control section 73 performs control concerning the camera shake correction function. That is, on the basis of the vibration of the digital camera 1, in other words, on the basis of the two angular velocities inputted from the vibration sensor 40, the camera shake control section 73 outputs a signal to the actuator driving section 26, and thereby moves and controls the CCD 5 appropriately so as to correct the camera shake.

The electric current value control section 74 outputs a signal to the actuator driving section 26, and thereby controls and changes the drive current value for driving the actuators 511 and 531. As described above, the drive current value serves as the control value specifying the camera shake correction performance and the silence performance of the digital camera 1. The electric current value control section 74 adjusts the drive current value on the basis of the sound level of the environmental sound obtained through the microphone 24.

<1-2. Outline of Operation>

The camera shake correction function of the digital camera 1 is activated in the “static image photographing mode” and the “video shooting mode”. Basic operation of the digital camera 1 is first described below for the “static image photographing mode” and the “video shooting mode”. Then, description is given for the operation concerning the camera shake correction function.

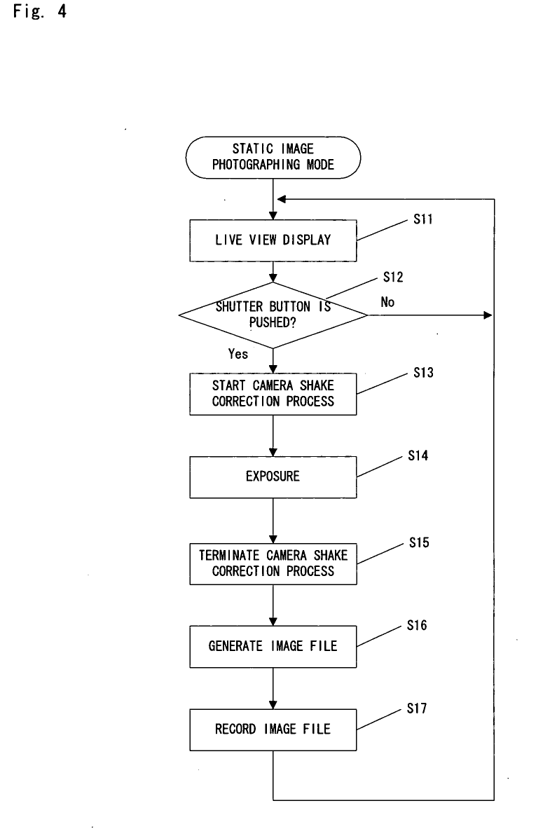

First, operation in the “static image photographing mode” is described below. FIG. 4 is a diagram showing the outline of operation in the “static image photographing mode” of the digital camera 1. In the “static image photographing mode”, the digital camera 1 first goes into a photographing standby state in which an operation of the shutter button 61 is awaited. In the photographing standby state, until the shutter button 61 is pushed (during the state of No at step S12), live view display is performed in the display section 63. That is, the image acquired by the CCD 5 for every predetermined time undergoes predetermined processing in the image processing section 23 and the like, and then is successively displayed on the display section 63 (step S11).

When the shutter button 61 is pushed (Yes at step S12), the system control section 7 first performs photographing preparation processing such as the exposure control (AE) and the focus control (AF). Then, under the control of the camera shake control section 73, camera shake correction processing is started in which the CCD 5 is moved so that the shake of the object image is suppressed (step S13).

Then, exposure is performed by the CCD 5 so that an image is acquired (step S14). When the exposure is completed in the CCD 5, the camera shake correction processing is terminated (step S15). After that, the acquired image undergoes predetermined processing in the image processing section 23 so that an image file is generated (step S16). Then, under the control of the system control section 7, the generated image file is recorded into the memory card 91 (step S17). When the image file is recorded, the digital camera 1 returns to the photographing standby state again.

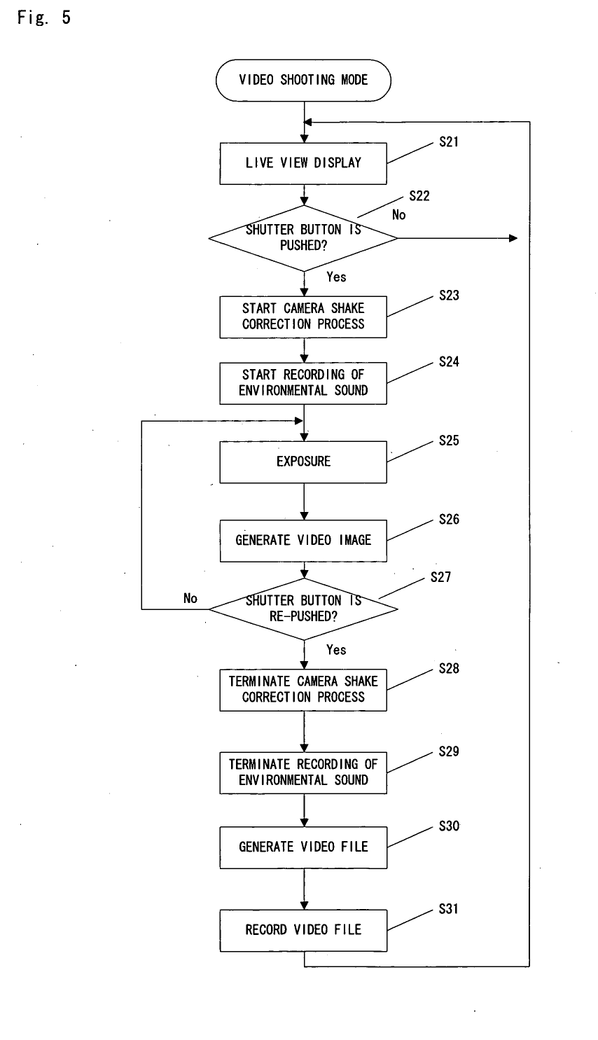

Next, operation in the “video shooting mode” is described below. FIG. 5 is a diagram showing the outline of operation in the “video shooting mode” of the digital camera 1. In the “video shooting mode”, the digital camera 1 first goes into a photographing standby state in which an operation of the shutter button 61 is awaited. Then, similarly to the “static image photographing mode”, until the shutter button 61 is pushed (during the state of No at step S22), live view display is performed in the display section 63 (step S21).

When the shutter button 61 is pushed (Yes at step S22), the photographing preparation processing of AE, AF, and the like is performed. At the same time, under the control of the camera shake control section 73, camera shake correction processing is started in which the CCD 5 is moved so that the shake of the object image is suppressed (step S23). Further, for the purpose of recording the environmental sound (audio) to be added to the video image, the recording of the environmental sound through the microphone 24 is started (step S24).

Then, exposure is performed by the CCD 5 so that an image is acquired (step S25). This acquisition of the image by the CCD 5 is repeated until the shutter button 61 used for instructing the termination of the video shooting is pushed again (during the state of No at step S27). During the time that this image acquisition is repeated, in parallel to this, processing of combining the successively acquired images and thereby generating a video image is performed in the image processing section 23 (step S26).

When the shutter button 61 is pushed again in this state (Yes at step S27), the video shooting (repeating the acquisition of the image and the generation of the video image) is terminated. At the same time, the camera shake correction processing and the acquisition of the environmental sound are also terminated (steps S28 and S29). Then, the environmental sound acquired through the microphone 24 is added to the generated video image by the image processing section 23 so that a video file is generated (step S30). The generated video file is recorded into the memory card 91 under the control of the system control section 7 (step S31). When the video file is recorded, the digital camera 1 returns to the photographing standby state again.

<1-3. Camera Shake Correction Processing>

As such, camera shake correction processing is performed during the exposure of the CCD 5 (FIG. 4: steps S13-S15) in the “static image photographing mode” and during the video shooting (FIG. 5: steps S23-S28) in the “video shooting mode” respectively under the control of the camera shake control section 73. The flow of this camera shake correction processing is described below.

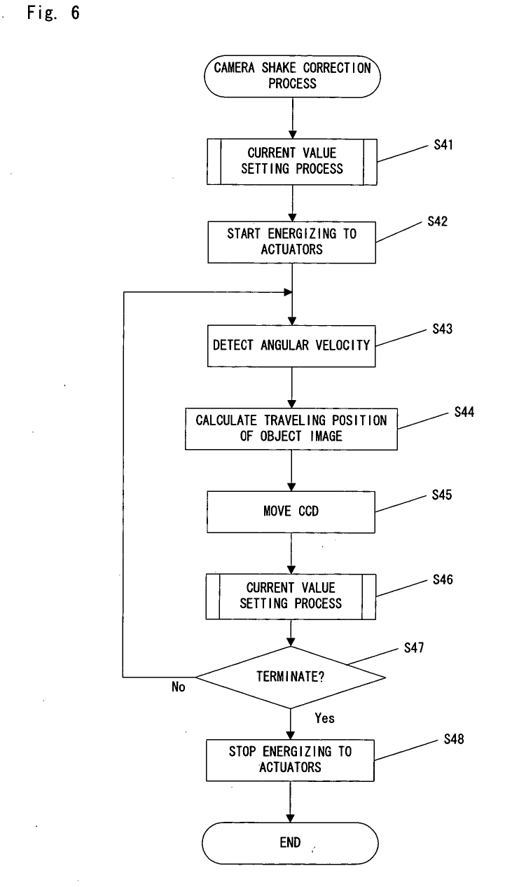

FIG. 6 is a diagram showing the flow of operation of camera shake correction processing. First, the electric current value control section 74 performs electric current value setting processing (described later in detail) of setting the drive current value for driving the actuators 511 and 531 (step S41). Then, the electric current value control section 74 outputs a signal to the actuator driving section 26 so as to start the energization to the actuators 511 and 531. At that time, the drive current value is set at the value having been set up in the electric current value setting processing (step S42).

After that, the moving operation (steps S43-S45) of the CCD 5 for suppressing the camera shake (shake of the object image) is repeated under the control of the camera shake control section 73. That is, the two angular velocities are detected by the vibration sensor 40 (step S43). Then, the position of traveling of the object image relative to the entire image circle is calculated on the basis of the two angular velocities (step S44). After that, on the basis of the calculated position of traveling of the object image, the direction and the amount are calculated for the to-be-performed traveling of the CCD 5. Then, the actuator driving section 26 transmits driving signals to the actuators 511 and 531 such that the CCD 5 should travel in the calculated direction by the calculated amount. As a result, the CCD 5 is moved such that the object image in the image circle does not displace relative to the light acceptance surface of the CCD 5 (step S45).

This moving operation of the CCD 5 (steps S43-S45) is repeated until the exposure of the CCD 5 is completed in the “static image photographing mode” and until the video shooting is completed in the “video shooting mode” (step S47). Further, during the time that the moving operation of the CCD 5 is repeated, the electric current value setting processing is also repeated by the electric current value control section 74 (step S46).

When the moving operation of the CCD 5 is to be terminated (Yes at step S47), the energization to the actuators 511 and 531 is stopped (step S48) so that the camera shake correction processing is terminated.

<1-4. Electric Current Value Setting Processing>

As described above, in the camera shake correction processing, before the moving operation (steps S43-S45) of the CCD 5 is performed (step S41) and in the course of repeating this operation (step S46), the electric current value control section 74 performs electric current value setting processing. In the electric current value setting processing, the drive current value for the actuators 511 and 531 is changed appropriately so that the camera shake correction performance and the silence performance are adjusted in the camera shake correction processing.

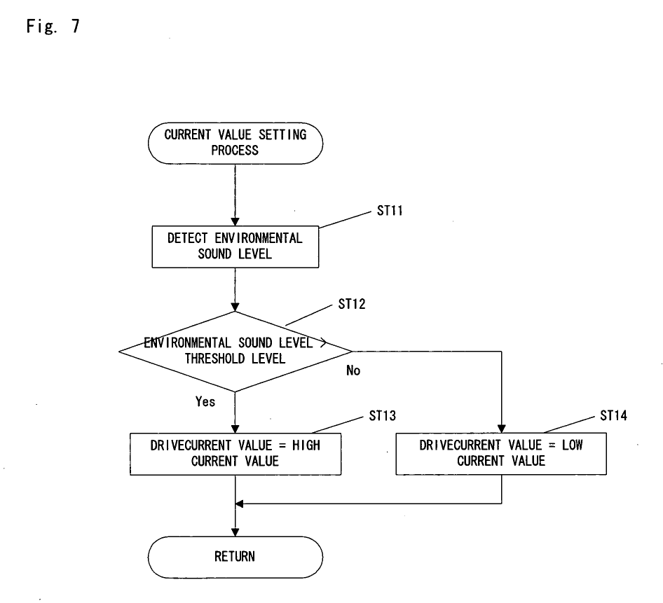

FIG. 7 is a diagram showing the flow of the electric current value setting processing. In the electric current value setting processing, first, the sound level (“environmental sound level”, hereafter) of the environmental sound is detected on the basis of the environmental sound acquired through the microphone 24. In the “video shooting mode”, the environmental sound is acquired for the audio to be added to the video image. Thus, this environmental sound can be used directly (step ST11).

Then, the environmental sound level is compared with a predetermined threshold value (step ST12). The drive current value is set up on the basis of the comparison result. That is, when the environmental sound level is higher than the threshold value, the drive current value is set at a comparatively high electric current value (an electric current value higher than a reference electric current value serving as the reference) (step ST13). When the environmental sound level is lower than the threshold value, the drive current value is set at a comparatively low electric current value (an electric current value lower than the reference electric current value serving as the reference) (step ST14) The threshold value, the high electric current value, and the low electric current value described here are respectively stored in the ROM 72 or the like in advance.

As such, when the environmental sound level is comparatively high, the drive current value is set to be comparatively high so that the camera shake correction performance is improved. Nevertheless, the driving sound level becomes high so that the silence performance is degraded. On the contrary, when the environmental sound level is comparatively low, the drive current value is set to be comparatively low. Thus, the driving sound level becomes low so that the silence performance is improved. Nevertheless, the camera shake correction performance is degraded. In other words, in the relation between the requirement of “improvement in the camera shake correction performance” and the requirement of “improvement in the silence performance”, priority is imparted to the “camera shake correction performance” when the environmental sound level is comparatively high, while priority is imparted to the “silence performance” when the environmental sound level is comparatively low.

In general, the degree (severity of problem caused by the driving sound) that the driving sound of the CCD moving section 50 causes unpleasant feeling to a person varies depending on the environmental sound level. When the environmental sound level is comparatively high, the driving sound is relatively small so that the severity of problem is low. That is, in this case, the driving sound does not cause annoyance to the neighbors. Further, even when the driving sound mixes into the audio of the video file, a large influence is not caused as a noise. Thus, when the environmental sound level is comparatively high, the drive current value is set to be comparatively high so that the silence performance is sacrificed that causes little problem, while priority is imparted to the “camera shake correction performance”.

On the contrary, when the environmental sound level is comparatively low, the driving sound is relatively large so that the severity of problem is high. That is, in this case, the driving sound can cause annoyance in a place such as a museum and an exhibition hall where silence is requested. Further, when the driving sound mixes into the audio of the video file, a large influence is caused as a noise. Thus, when the environmental sound level is comparatively low, the drive current value is set to be comparatively low so that the camera shake correction performance is somewhat sacrificed, while priority is imparted to the “silence performance”.

### 1-5. CONCLUSION

As described above, in the digital camera 1 of the present embodiment, the environmental sound is detected. Then, the drive current value is set up depending on the sound level. This permits appropriate balance between the silence performance and the camera shake correction performance. More specifically, when the environmental sound level is comparatively low, the drive current value is set to be low. This improves the silence performance, and hence efficiently avoids various kinds of problem which could be caused by the driving sound. On the contrary, when the environmental sound level is high, the drive current value is set to be high. This improves the camera shake correction performance.

### 2. Second Embodiment

Next, a second embodiment of the invention is described below. The configuration and the processing of the digital camera 1 of the present embodiment are almost the same as those of the first embodiment. Thus, the following description is given with focusing attention on the difference. In the camera shake correction processing of the first embodiment, the function (“electric current value changing function”, hereafter) of changing the drive current value in the electric current value control section 74 has always been activated, so that the “camera shake correction performance” and the “silence performance” have been changed appropriately. Nevertheless, in a possible case, a user desires that either the “camera shake correction performance” or the “silence performance” should be maximized always. Thus, the digital camera 1 of the present embodiment allows the user to set up whether the “camera shake correction performance” and the “silence performance” are to be changed or fixed.

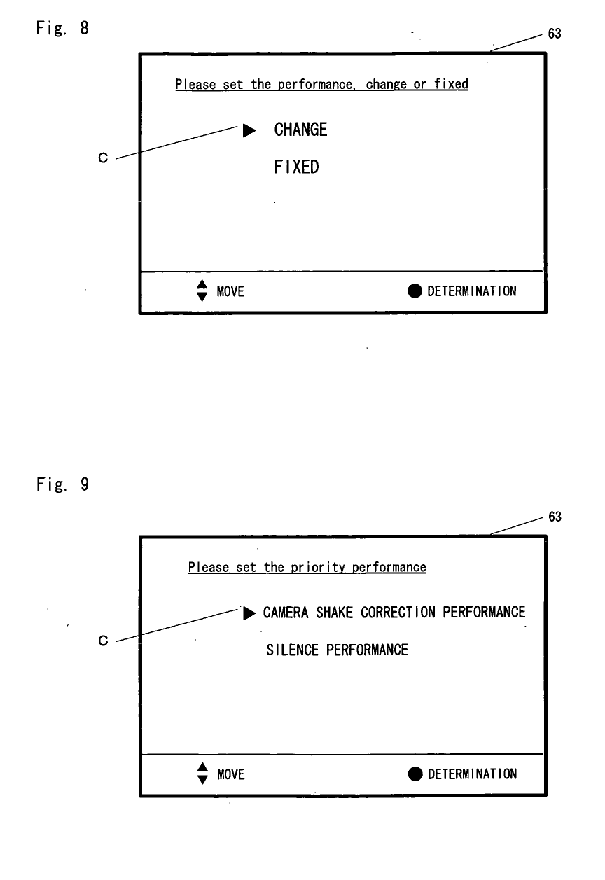

FIG. 8 is a diagram showing a setting menu used for receiving a setting (“performance change setting”, hereafter) whether the “camera shake correction performance” and the “silence performance” are to be changed or fixed. This setting menu is displayed on the display section 63 in response to a predetermined operation performed via the operating member 62 in the photographing standby state for the “static image photographing mode” or the “video shooting mode”.

As shown in FIG. 8, this screen displays “change” and “fixed” in a manner selectable as the setting item for the “performance change setting”. Here, the “change” indicates that the electric current value changing function is activated so that the “camera shake correction performance” and the “silence performance” are changed appropriately. The “fixed” indicates that the electric current value changing function is inactivated so that the “camera shake correction performance” and the “silence performance” are fixed. Thus, the operation that a “performance change setting” is received from the user as described here corresponds substantially to that an activation setting whether the electric current value changing function is to be activated or not is received from the user.

In this screen, the user operates the cross key, thereby moves the cursor C to a desired setting item, and then pushes the determination button so as to confirm as the setting contents the setting item selected with the cursor C. The setting contents of “performance change setting” confirmed here is received by the system control section 7, and then stored into the RAM 71.

When the “fixed” is set as the “performance change setting” (in the case of setting that the electric current value changing function is to be inactivated), a setting menu used for receiving a setting (“performance priority setting”, hereafter) that indicates a performance to which priority is to be imparted when the “camera shake correction performance” and the “silence performance” are fixed is displayed on the display section 63 as shown in FIG. 9.

In the screen, the “camera shake correction performance” and the “silence performance” are displayed in a manner selectable as the setting item for the “performance priority setting”. Here, the “camera shake correction performance” indicates that priority is imparted to the camera shake correction performance and that the drive current value is fixed at a high electric current value. On the other hand, the “silence performance” indicates that priority is imparted to the silence performance and that the drive current value is fixed at a low electric current value. Thus, the operation that a “performance priority setting” is received from the user as described here corresponds substantially to that a user setting value (the “high electric current value” or the “low electric current value”) to be set up as the drive current value is received from the user.

Also in this screen, the user operates the cross key and the determination button, and thereby confirms a desired setting item as the setting contents. The setting contents of “performance priority setting” confirmed here is similarly received by the system control section 7, and then stored into the RAM 71.

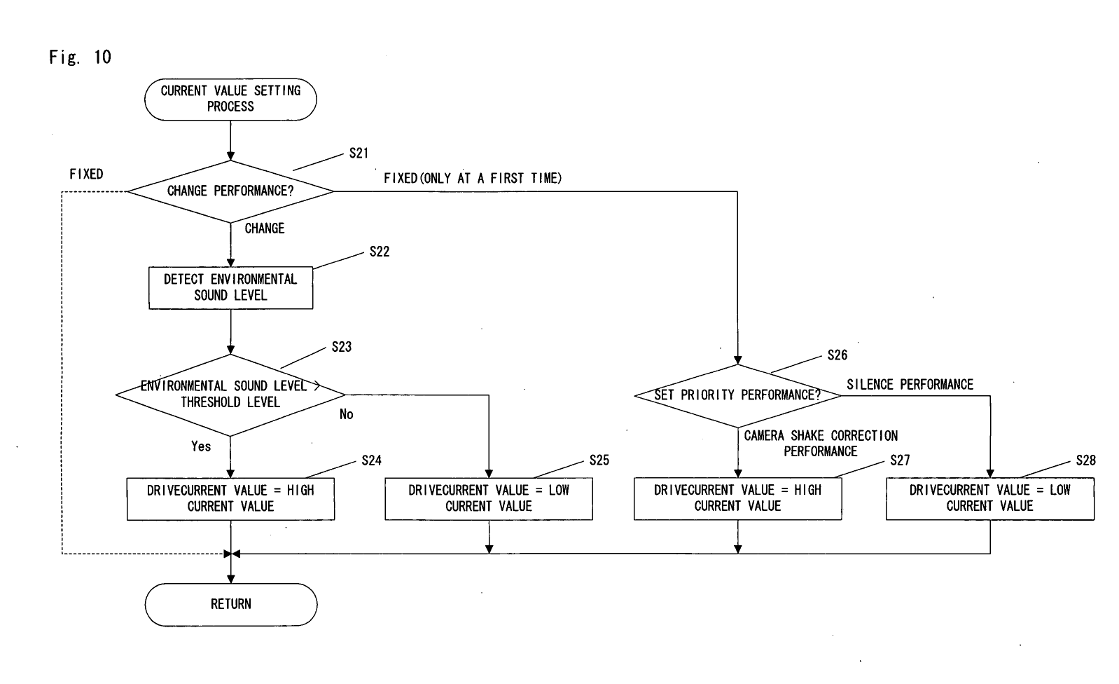

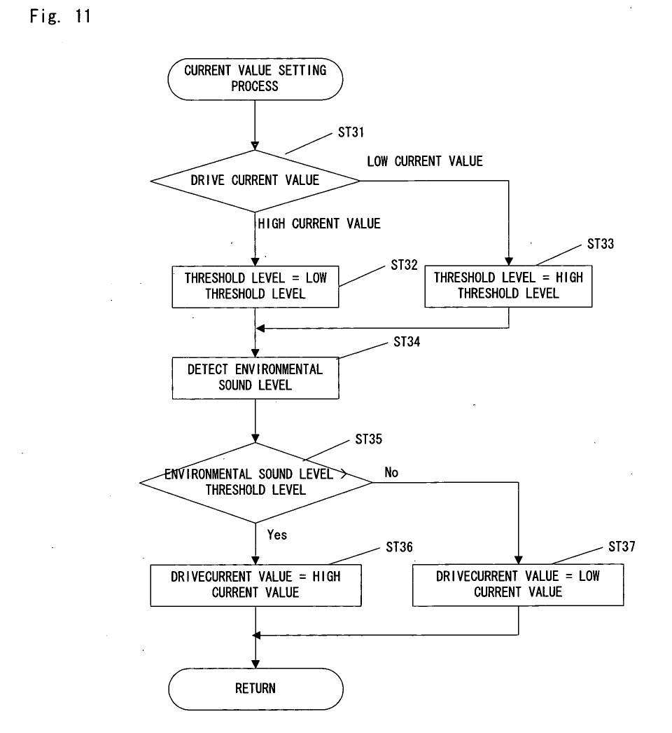

In the digital camera 1 of the present embodiment, electric current value setting processing is performed depending on the “performance change setting” and the “performance priority setting” having been set up as described above. FIG. 10 is a diagram showing the flow of electric current value setting processing of the present embodiment. Similarly to the first embodiment, the electric current value setting processing is performed: before the moving operation of the CCD 5 is performed in the camera shake correction processing (FIG. 6: step S41); and in the course of repeating this operation (FIG. 6: step S46). The electric current value setting processing of the present embodiment is described below with reference to the diagram.

First, it is determined whether the “performance change setting” is set at “change “or “fixed” (step ST21). When the “performance change setting” is set at “change”, the electric current value changing function is activated. Thus, at steps ST22-ST25, the same processing as that (FIG. 7: steps ST11-ST14) of the first embodiment is performed. That is, the drive current value is set up depending on the environmental sound level so that the “camera shake correction performance” and the “silence performance” are changed.

When the “performance change setting” is set at “fixed”, the electric current value changing function is inactivated. Thus, the changing of the drive current value depending on the environmental sound level is no longer performed. Then, the “performance priority setting” is referred to (step ST26), so that when the “performance priority setting” is the “camera shake correction performance”, the drive current value is set at a high electric current value having been set up by the user (step ST27). When the “performance priority setting” is the “silence performance”, the drive current value is set at a low electric current value having been set up by the user (step ST28). The processing of these steps ST26-ST28 is performed only once only at the first time of electric current value setting processing in the camera shake correction processing, so that the drive current value is fixed for the subsequent operation.

As described above, in the digital camera 1 of the present embodiment, the activation setting whether the electric current value changing function is to be activated or not can be received from the user. Then, the electric current value changing function is activated or inactivated according to the activation setting having been set up. Accordingly, when the user desires, the “camera shake correction performance” and the “silence performance” can be prevented from being changed.

Further, a user setting value to be set as the drive current value when the electric current value changing function is to be inactivated is received from the user, so that the drive current value is fixed to the user setting value. This allows the user to desire and select whether priority should be imparted to the “camera shake correction performance” or the “silence performance”.

### 3. Third Embodiment

Next, a third embodiment of the invention is described below. The configuration and the processing of the digital camera 1 of the present embodiment are almost the same as those of the first embodiment. Thus, the following description is given with focusing attention on the difference. In the first embodiment, the threshold value to be compared with the environmental sound level has been fixed. Nevertheless, in the case that the threshold value is fixed, when the environmental sound level fluctuates across the threshold value in the vicinity of the threshold value, the “camera shake correction performance” and the “silence performance” are changed at each time that the environmental sound level passes the threshold value. This causes frequent changes in the driving sound level, and hence can cause a problem that for example, the change phenomenon itself in the driving sound level serves as a noise. Thus, in the electric current value setting processing of the present embodiment, the threshold value is changed appropriately so as to avoid such a phenomenon.

FIG. 11 is a diagram showing the flow of electric current value setting processing of the present embodiment. Similarly to the first embodiment, the electric current value setting processing is performed: before the moving operation of the CCD 5 is performed in the camera shake correction processing (FIG. 6: step S41); and in the course of repeating this operation (FIG. 6: step S46). The electric current value setting processing of the present embodiment is described below with reference to the diagram.

First, the presently set-up drive current value is referred to, so that it is determined which of a high electric current value and a low electric current value is set up as the drive current value (step ST31). When the drive current value is set at the high electric current value, the threshold value is set at a comparatively low value called a “low threshold value” (a threshold value lower than a reference threshold value serving as the reference) (step ST32). On the contrary, when the drive current value is set at the low electric current value, the threshold value is set at a comparatively high value called a “high threshold value” (a threshold value higher than the reference threshold value serving as the reference) (step ST33).

After that, the same processing as that (FIG. 7: steps ST11-ST14) of the first embodiment is performed. That is, the environmental sound level is detected (step ST34). Then, the environmental sound level is compared with the threshold value having been set up (step ST3S). When the environmental sound level is higher than the threshold value, the drive current value is set at the high electric current value (step ST36). When the environmental sound level is lower than the threshold value, the drive current value is set at the low electric current value (step ST37).

For example, at a specific time point (“first time point”, hereafter), the environmental sound level is assumed to become higher than the threshold value, so that the drive current value is assumed to be changed from the low electric current value into the high electric current value. At the first time point, the drive current value is still at the low electric current value. Thus, the threshold value is set at the “high threshold value”. Then, after the first time point, the drive current value is changed into the high electric current value, so that the threshold value is set at the “low threshold value”. That is, when the environmental sound level has once become higher than the “high threshold value”, the drive current value is not changed after that unless the environmental sound level becomes lower than the “low threshold value” (<“high threshold value”).

On the contrary, at a specific time point (“second time point”, hereafter), the environmental sound level is assumed to become lower than the threshold value, so that the drive current value is assumed to be changed from the high electric current value into the low electric current value. At the second time point, the drive current value is still at the high electric current value. Thus, the threshold value is set at the “low threshold value”. Then, after the second time point, the drive current value is changed into the low electric current value, so that the threshold value is set at the “high threshold value”. That is, when the environmental sound level has once become lower than the “low threshold value”, the drive current value is not changed after that unless the environmental sound level becomes higher than the “high threshold value” (>” low threshold value”).

As such, in the digital camera 1 of the present embodiment, when the drive current value is once changed, the threshold value is adjusted such that the drive current value should not immediately be changed. This avoids that the driving sound level is changed frequently.

### 4. Fourth Embodiment

Next, a fourth embodiment of the invention is described below. The configuration and the processing of the digital camera 1 of the present embodiment are almost the same as those of the first embodiment. Thus, the following description is given with focusing attention on the difference. In the third embodiment, the threshold value has been adjusted so that frequent changes have been avoided in the driving sound level. In contrast, in the present embodiment, when the drive current value is once changed, the drive current value is not further changed until a predetermined time elapses since the time point of the change, so that frequent changes are avoided in the driving sound level.

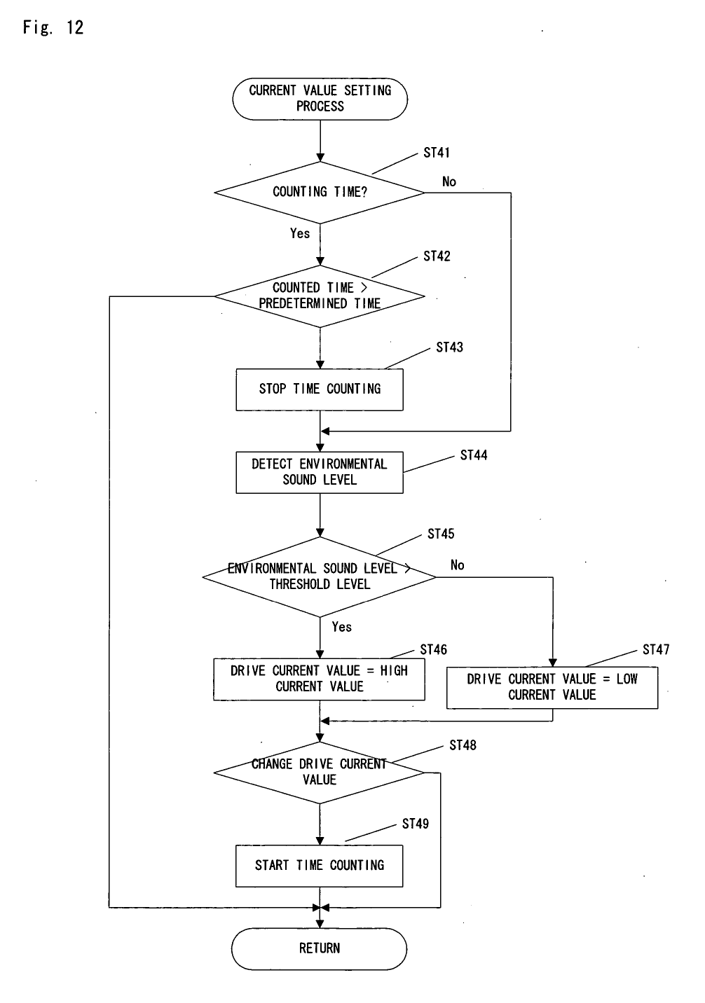

FIG. 12 is a diagram showing the flow of electric current value setting processing of the present embodiment. Similarly to the first embodiment, the electric current value setting processing is performed: before the moving operation of the CCD 5 is performed in the camera shake correction processing (FIG. 6: step S41); and in the course of repeating this operation (FIG. 6: step S46). The electric current value setting processing of the present embodiment is described below with reference to the diagram.

First, it is determined whether the timer 79 of the system control section 7 is under the time counting (step ST41). As described later in detail, the timer 79 starts the time counting when the drive current value is changed (steps ST48 and ST49). When the timer 79 is not under the time counting, the procedure goes immediately to step ST44.

At steps ST44-ST47, the same processing as that (FIG. 7: steps ST11-ST14) of the first embodiment is performed. That is, the environmental sound level is detected (step ST44). Then, the environmental sound level is compared with the threshold value having been set up (step ST45). When the environmental sound level is higher than the threshold value, the drive current value is set at the high electric current value (step ST46). When the environmental sound level is lower than the threshold value, the drive current value is set at the low electric current value (step ST47).

When the drive current value is set up, it is determined whether the drive current value has been changed in this setup (step ST48). When the drive current value has been changed, the time counting in the timer 79 is started (step ST49). Thus, the counted time in the timer 79 indicates the time having elapsed from the time point of the latest change of the drive current value.

At step ST41, when the timer 79 is under the time counting (Yes at step ST41), it is determined whether the counted time exceeds a predetermined time (for example, 5-10 seconds) (step ST42). When the counted time does not exceed the predetermined time (No at step ST42), the electric current value setting processing is immediately terminated. That is, the processing of changing the drive current value depending on the environmental sound level (steps ST44-ST47) is not performed. In other words, until the predetermined time elapses since the time point of change of the drive current value, the function (electric current value changing function) of changing the drive current value in the electric current value control section 74 is inactivated.

After the counted time exceeds a predetermined time (Yes at step ST42), the time counting in the timer 79 is stopped (step ST43). Then, the processing of changing the drive current value depending on the environmental sound level (steps ST44-ST47) is performed. That is, the electric current value changing function is activated.

As such, in the digital camera 1 of the present embodiment, until a predetermined time elapses after the changing of the drive current value, the electric current value changing function is inactivated. Accordingly, when the drive current value has once been changed, the control value is not immediately changed after that. This avoids that the driving sound level is changed frequently.

<5. Modifications>

Embodiments of the invention have been described above. However, the invention is not limited to these embodiments, and various modifications are possible.

In the above-mentioned embodiments, the camera shake correction method has been such that the image pickup device is moved. However, the invention is not limited to this. That is, another method may be employed as long as the position of the optical image (image circle) formed through the taking lens is changed relative to a part of the area acquired as an image. For example, a part of correcting lenses in the taking lens may be moved in the XY plane.

Further, in the above-mentioned embodiments, the drive current value has been changed and used as the camera shake correction function control value that influences the driving sound level. However, for example, another control value such as the drive voltage value, the drive frequency, and the driving duty ratio may be changed. Here, the drive voltage value indicates a pressure value applied to the actuator. The drive frequency indicates the inverse number of a driving period (time interval) in which the moving operation of the CCD 5 is performed. The driving duty ratio indicates a time ratio in which a voltage is applied within the driving period. When any one of these control values is changed, the driving speed of the actuators 511 and 531 varies in response to this, so that the camera shake correction performance and the silence performance are changed similarly to the above-mentioned embodiments. Alternatively, a plurality of control values may be changed that are selected from the drive current value, the drive voltage value, the drive frequency, the driving duty ratio, and the like.

Further, in the above-mentioned embodiments, the control value has been changed in two steps. However, the control value may be changed in three or more steps. Further, the actual the environmental sound level may be substituted into a predetermined function of the environmental sound level, so that the control value may be calculated.

Further, in the above-mentioned embodiments, the control value has been changed on the basis of the environmental sound level. However, for example, the control value may be changed on the basis of another state of environment such as ambient light and environmental temperature. For example, RGB distribution is detected for the ambient light so that it is determined whether the ambient light is sunlight or artificial light. Then, in the case of sunlight (in particular, in the case of intense sunlight), it is expected that the photographing is performed outdoors. Then, in the outdoors, a higher driving sound level of the camera shake correcting means is allowed in many cases in comparison with the indoors. Thus, in the case of photographing under the sunlight, the drive current value of the camera shake correcting means may be controlled in a not reduced state. Alternatively, the control value may be changed on the basis of the combination of the state of environmental sound level and another state of environment. Further, in addition to the environmental sound level, another quantitative property of the environmental sound (such as the value of frequency of the environmental sound) may be incorporated so that the control value may be changed.

The digital camera described as an example of an imaging apparatus in the above-mentioned embodiments has been capable of acquiring both of a static image and a video image. However, the technique of the invention is applicable also to an imaging apparatus capable of acquiring solely either a static image or a video image. Further, the technique of the invention is not limited to a digital camera, but is applicable also to a film-based camera using a silver halide film.

As described above, the imaging apparatus of the invention comprises: image pickup means for acquiring as an image a part of region of an optical image formed by a taking lens; camera shake correcting means for changing a relative position between the part of region and the optical image depending on a vibration of the imaging apparatus, and thereby suppressing a shake of the object image in the image; state detecting means for detecting a state of an environment where the imaging apparatus is located; and changing means for changing a control value of the camera shake correcting means which influences a driving sound level of the camera shake correcting means, depending on the state of environment. According to this configuration, the control value of the camera shake correcting means is changed depending on the state of environment. This permits appropriate balance between the silence performance and the camera shake correction performance.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. An imaging apparatus, comprising:
an image pickup device for acquiring as an image a part of region of an optical image formed by a taking lens;
a camera shake correcting device for changing a relative position between the part of region and the optical image depending on a vibration of the imaging apparatus, and thereby suppressing a shake of the object image in the image;
a state detecting device for detecting a state of an environment where the imaging apparatus is located; and
a changing device for changing a control value of the camera shake correcting device which influences a driving sound level of the camera shake correcting device, depending on the state of environment.

2. An imaging apparatus according to claim 1, wherein the state detecting device includes sound detecting unit for detecting environmental sound,
wherein the changing device changes the control value depending on the sound level of the environmental sound.

3. An imaging apparatus according to claim 2, further comprising:
a generating device for generating a video image on the basis of the image acquired by the image pickup device; and
a recording device for recording as a video file the video image together with the environmental sound.

4. An imaging apparatus according to claim 2, wherein the changing device sets the control value to be a first value causing the driving sound level to become comparatively high when the sound level of the environmental sound is higher than a threshold value, and sets the control value to be a second value causing the driving sound level to become comparatively low when the sound level of the environmental sound is lower than the threshold value.

5. An imaging apparatus according to claim 1, further comprising:
a first receiving device for receiving from a user an activation setting that specifies whether the changing device is to be activated or not,
wherein the changing device is activated or inactivated according to the activation setting.

6. An imaging apparatus according to claim 5, further comprising:
a second receiving device for receiving from a user a user setting value to be set as the control value when the changing device is inactivated,
wherein when the changing device is inactivated, the control value is set to be the user setting value.

7. An imaging apparatus according to claim 4, further comprising:
a threshold value setting device in which when the control value is at the first value, the threshold value is set to be comparatively small, while when the control value is at the second value, the threshold value is set to be comparatively large.

8. An imaging apparatus according to claim 1, wherein the changing device is inactivated until a predetermined time elapses after the changing device has changed the control value.

9. A shake correction control apparatus for a shake correction apparatus comprising image pickup device for acquiring as an image a part of region of an optical image formed by a taking lens and a camera shake correcting device for changing a relative position between the part of region and the optical image depending on a vibration, and thereby suppressing a shake of the object image in the image; wherein the shake correction control apparatus, comprising:
a state detecting device for detecting a state of an environment where the shake correction apparatus is located; and
a changing device for changing a control value of the camera shake correcting device which influences a driving sound level of the camera shake correcting device, depending on the state of environment.

10. A shake correction control apparatus according to claim 9, wherein the state detecting device includes sound detecting unit for detecting environmental sound,
wherein the changing device changes the control value depending on the sound level of the environmental sound.

11. A shake correction control apparatus according to claim 10, wherein the changing device sets the control value to be a first value causing the driving sound level to become comparatively high when the sound level of the environmental sound is higher than a threshold value, and sets the control value to be a second value causing the driving sound level to become comparatively low when the sound level of the environmental sound is lower than the threshold value.

12. A shake correction control apparatus according to claim 9, further comprising:
a first receiving device for receiving from a user an activation setting that specifies whether the changing device is to be activated or not,
wherein the changing device is activated or inactivated according to the activation setting.

13. A shake correction control apparatus according to claim 9, wherein the changing device is inactivated until a predetermined time elapses after the changing device has changed the control value.

14. A shake correction controlling method for a shake correction apparatus comprising a image pickup device for acquiring as an image a part of region of an optical image formed by a taking lens and a camera shake correcting device for changing a relative position between the part of region and the optical image depending on a vibration, and thereby suppressing a shake of the object image in the image; wherein the shake correction controlling method comprising:
state detecting step in which a state detecting device detects a state of an environment where the shake correction apparatus is located; and
changing step in which a changing device changes a control value of the camera shake correcting device which influences a driving sound level of the camera shake correcting device, depending on the state of environment.
